(19) United States
(12) Patent Application Publication
(10) Pub. No.: US 2005/0256978 A1
(43) Pub. Date: Nov. 17, 2005

(54) Method for controlling home network system

(76) Inventor: Koon Seok Lee, Kyongsangnam-do (KR)

Correspondence Address: MCKENNA LONG & ALDRIDGE LLP, 1900 K STREET, NW, WASHINGTON, DC, 20006, US

(21) Appl. No.: 10/506,432

(22) PCT Filed: Apr. 10, 2002
(86) PCT No.: PCT/KR02/00656

§ 371 Date: Sep. 2, 2004

(30) Foreign Application Priority Data
Mar. 30, 2002 (KR) 2002/17630

(51) Int. Cl. G06F 13/10

(52) U.S. Cl. 710/8

(57) ABSTRACT

A method for controlling a home network system is disclosed. The method includes a step for inputting control data; a step for generating a file by the input control data; a step for transmitting the generated file to a corresponding appliance; and a step for performing a corresponding control function by analyzing the transmitted file.

### TECHNICAL FIELD

The present invention relates to a home network system, more particularly, to a method for controlling a home network system.

### BACKGROUND ART

Although ‘Home Automation’ first started to automatically control home appliances from somewhere in the house or from a remote place, the appliances were not connected to each other, and one had to deal with each appliance individually by using telephone or infrared rays. Recently however, all electronic apparatuses are networked together with help of a communication means, and a home network system for integrative control on the network through a controller is going to be available to the public in no time.

In addition, considering the fact that even same kinds of electric appliances manufactured by the same company can have different functions according to different models, a constant control code's structure, which is applicable to the same kinds of electric appliances despite their different their model name or manufacturer, is more than necessary to configure a home network.

In the past, there were two methods for creating a control code for an electric appliance.

One is to create a control code based on function, namely a function-centered control code, and the other is to create a control code based on state, namely a state-centered control code.

As shown in Table 1, the function-centered control code has different factors per command code, and can comprehensively control various states of an appliance.

TABLE 1

| | | | | |
|---|---|---|---|---|
| Command code | Factor 1 | Factor 2 | . . . | Factor N |

Here, command code means functions, and each factor means a method for performing the functions. That is, a command code for turning on air conditioner is ‘power on/off’, and its factor could be a highest temperature or running mode.

In addition, although the state-centered control code, as shown in FIG. 2, seems to be the same with Table 1 in terms of different factors per command code, it is different in that a single state of an appliance can be controlled.

TABLE 2

| | | | | |
|---|---|---|---|---|
| Command code | Factor 1 | Factor 2 | . . . | Factor N |

The control codes in this case can carry out an independent single function, and control a single state of an appliance. In case of air conditioner as an example, the control code can control mode like “temperature setting”, “wind direction setting”, “running mode setting” and so on. The factors at this time are always constant, and easily standardized because they control a state that does not change according to model name or manufacturer of the air conditioner.

However, the code generation method for electric home appliances in a home network system according to the present invention has the following drawbacks.

First, when control codes are centered on function, number and function of factors can be different, depending on model name or manufacturer of appliances. In other words, it is very difficult to configure a home network with appliances made by different manufacturers because communication among the appliances is impossible.

Second, when control codes are centered on state, and a user wants to control an appliance, e.g., an air conditioner, the user soon realizes that it is actually very inconvenient to transmit control codes four times in a row especially when four kinds of states need to be controlled at the same time.

Third, it takes longer to control appliances to generate a state-centered control code, given that a network is configured at low-speed communication.

### DISCLOSURE OF INVENTION

It is, therefore, an object of the present invention to provide a method for controlling a home network system for controlling electric home appliances by a consistent control code in a home network.

To achieve the above object, there is provided the method for controlling a home network system, including the steps of: inputting control data; generating a file by the input control data; transmitting the generated file to a corresponding appliance; and performing a corresponding control function by analyzing the transmitted file.

### BRIEF DESCRIPTION OF DRAWINGS

The above objects, features and advantages of the present invention will become more apparent from the following detailed description when taken in conjunction with the accompanying drawings, in which:

FIG. 1 is a flow chart illustrating a method for controlling a home network system in accordance with the present invention.

### BEST MODE FOR CARRYING OUT THE INVENTION

A preferred embodiment of the present invention will now be described with reference to the accompanying drawings.

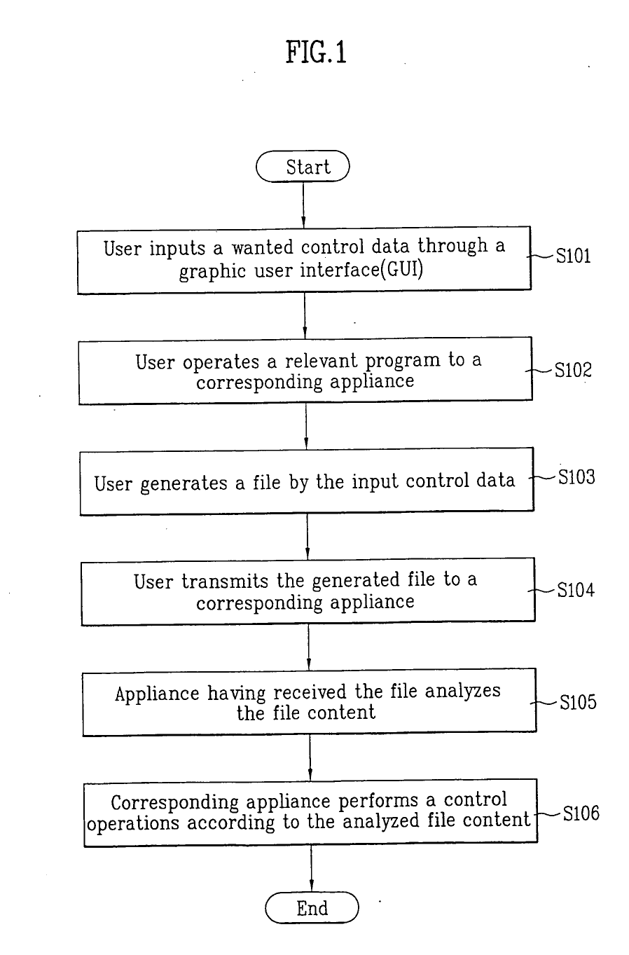

FIG. 1 diagrammatically explains a method for controlling a home network system in accordance with the present invention.

As shown in the drawing, first a user inputs a wanted control data through a graphic user interface (GUI) (S101).

Next, the user operates a relevant program to a corresponding appliance (S102).

And, the user generates a file by the input control data (S103).

The user transmits the generated file to a corresponding appliance (S104).

Then, the appliance having received the file analyzes the file content, and finds out if the file format is proper to itself (S105).

At a result of the decision, if the file has a proper format for itself, the corresponding appliance is controlled according to the analyzed file content (S106).

In case of generating a control code in accordance with the above-described method of the present invention, every command code has the same factor as shown in Table 3.

TABLE 3

| | | | | |
|---|---|---|---|---|
| Command code | Factor 1 | Factor 2 | . . . | Factor N |

Here, from Factor 1 to Factor N indicate values for transmitting files or long data, as illustrated in Table 4.

TABLE 4

| | | | | |
|---|---|---|---|---|
| Current packet | Total number | Option | Number of data | Data array |
| number | of packets | | | |

Therefore, transmitting control codes means transmitting data files, and the format of data file can be different depending on the manufacturer of appliance. In general, a personal computer has a specific driver program for generating data file according to the manufacturer of the product.

In other words, if the user inputs data about a wanted appliance through GUI, a specific driver program per manufacturer is operated based on the input data and information on the corresponding appliance, e.g., manufacturer and model name. Then, a data array-type of file is generated per manufacturer of appliance, and the communication program transmits this file to the corresponding appliance by using a command code and a predetermined factor.

For example, suppose that a user wants to control the air conditioner. If the user selects “room temperature; 18° C.”, “wind direction: right and left”, “wind velocity: strong”, and “operating mode: standard” through GUI, the driver program generates a file having “18,0,2,0” data, and transmits the file to a corresponding air conditioner.

Then the air conditioner decides whether the data file is appropriate for itself, and if it is, starts operation in accordance with the command codes that are input by the user, i.e., “room temperature; 18° C.”, “wind direction: right and left”, “wind velocity: strong”, and “operating mode: standard”.

While the invention has been shown and described with reference to certain preferred embodiments thereof, it will be understood by those skilled in the art that various changes in form and details may be made therein without departing from the spirit and scope of the invention as defined by the appended claims.

### INDUSTRIAL APPLICABILITY

The method for controlling a home network system, more specifically, the method for creating codes for electric home appliances in the home network system according to the present invention has the following benefits:

First, by making every command have the same factor structure, it became much easier to adapt to different manufactures and models.

Second, as long as an appliance has a corresponding driver program, the codes can be exchanged with other appliances with different manufacturers although more functions could be added upon the appliances.

Third, because essential part of factor structure (data format of a file) for controlling every appliance is known to the manufacturer only, associated technologies can be protected from a possible infringement, and the driver file for controlling specific functions of the manufacturer can be charged.

1. A method for controlling a home network system, the method comprising the steps of:
inputting control data of a user;
generating a file by the input control data;
transmitting the generated file to a corresponding appliance; and
performing a corresponding control function by analyzing the transmitted file.

2. The method according to claim 1, wherein the step of generating the file by the input control data means generating a data array-type of file according to the input control data.

3. The method according to claim 1, wherein the step of transmitting the generated file to a corresponding appliance means transmitting the file to a corresponding appliance by utilizing an equal factor for every command.

4. The method according to claim 3, wherein the equal factor comprises current packet number, total number of packets, option, number of data, and data array format.

5. The method according to claim 4, wherein the control data by a user is transmitted in a file format to the data array area.
